(19) United States
(12) Patent Application Publication
(10) Pub. No.: US 2013/0110687 A1
(43) Pub. Date: May 2, 2013

(54) AUTOMATED RECONCILIATION OF PAYROLL AND TAX REPORTS

(71) Applicant: Sreesha M, Bangalore (IN)

(72) Inventor: Sreesha M, Bangalore (IN)

(73) Assignee: SAP AG, Walldorf (DE)

(21) Appl. No.: 13/338,373

(22) Filed: Dec. 28, 2011

(30) Foreign Application Priority Data
Oct. 31, 2011 (IN) 3728/CHE/2011

(51) Int. Cl. G06Q 40/00

(52) U.S. Cl. 705/31; 705/30

(57) ABSTRACT

The present disclosure involves systems, software, and computer implemented methods for reconciliation of payroll and tax reports. Multiple reports generated by a country-specific tax reporting system are received. The reports include common data that is common to the multiple reports. Each report includes specific data that is specific to a respective report. The common data are identifier. In response to receiving a query from a reconciliation system to reconcile the data in a tax report and in a payroll report, specific data that is specific to the tax report is identified. The common data and the specific data are provided to the reconciliation system in response to receiving the query.

### CROSS-REFERENCE TO RELATED APPLICATIONS

This application claims priority to Indian Application No. 3728/CHE/2011, filed on Oct. 31, 2011, entitled “Automated Reconciliation of Payroll and Tax Reports,” the entire contents of which are incorporated by reference.

### TECHNICAL FIELD

The present disclosure relates to software, computer systems, and computer implemented methods related to managing business operations.

### BACKGROUND

An organization typically includes several internal systems that manage flow of organizational processes. Certain systems can be configured to maintain financial data, particularly, the consistency and accuracy of financial data. Such systems can include a human resources (HR) payroll system which can process payments to employees and other human resources of an organization. The HR payroll system can also calculate various payments such as basic remuneration, overtime payments, bonuses, and other special payments. Relevant payroll results from the payroll system can be transferred or posted to a financial accounting system. The financial accounting system can be used to meet statutory requirements and to prepare operational information (for example, financial reports) of an organization. A financial accounting system can record and manage accounting data of an organization. Additional systems can include tax reporting systems that generate tax reports for the employees or for the organization or both.

Reports generated by the various systems can be compared by reconciliation processes. The comparison can be performed externally relative to the organizational systems, for example, using spreadsheets. Such externally performed comparisons can require manual effort and can be time consuming.

### SUMMARY

The present disclosure involves systems, software, and computer-implemented methods to obtain data distributed across multiple reports. Multiple reports generated by a first business operations system are received. Each report includes respective data. The multiple reports include common data that is common to the multiple reports. Each report includes specific data that is specific to a respective report. The common data is identified. In response to receiving a query for reconciliation of data in at least one report of the multiple reports and a report generated by a second business operations system, specific data that is specific to the at least one report is identified. At least a portion of the common data and the identified specific data are provided.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 illustrates an example environment for implementing various features of business operations systems that can perform reconciliation.

FIG. 2 illustrates example business operations systems to generate reports of payroll results.

FIG. 3 illustrates a data collection system to collect common data and specific data.

FIG. 4 illustrates examples of reports generated by the business operations systems.

FIG. 5 is a flowchart showing an example process to collect data distributed across multiple reports.

### DETAILED DESCRIPTION

This disclosure generally describes computer systems, software, and computer-implemented methods for automated reconciliation of payroll and tax reports, for example, by business operations systems implemented by organizations. An organization can include one or more business operations systems, for example, related to human resources (HR), payroll, finances, budgeting, accounting, taxes, expenses, and the like. Such business operations systems can be integrated as parts of an enterprise system. Each system can include associated databases and application components that provide user interfaces. Using respective application components, each business organization system can collect and store data in the associated databases. In addition, each business organization system can generate one or more reports to present the stored data.

One such business operations system is a country-specific tax reporting system, which can be configured to produce payroll tax and other reports for government authorities. The country-specific payroll tax reports can help the organization to report tax and other statutory contributions or deductions withheld. The other legal reports can help the organization to provide employees' payroll data to various agencies, for example, based on the laws of the respective countries in which the employees are employed.

Different countries can require that the tax reports and other legal reports be in different formats. For example, the United States government may require that a United States tax report (such as Form W2) have a particular format. Similarly, the Norwegian government may require that a Norwegian tax report (such as Annual Tax Statement) have another particular format. Moreover, the United States government may require that another United States tax report (such as Form 941) have a format that is different from both the Form W2 and the Annual Tax Statement. The country-specific tax reporting system can be configured to generate tax reports in formats specified by the particular countries.

Payroll reconciliation includes processes in which data in payroll results (i.e., reports generated by a payroll system) are compared with data in reports generated by other systems, such as the tax reporting system, to evaluate the accuracy and consistency of data flow between the payroll and other systems. Some of data in the various reports that the tax reporting system generates can be common across multiple reports (for example, employee identifier and name, employer identifier and name, and the like), while other data can be specific to each report (for example, country identifier, reporting frequency, and the like).

This disclosure describes techniques to reconcile the data in payroll reports with the data in reports generated by the tax reporting system. To do so, the tax reporting system is configured to include a generic framework that identifies common data distributed across the multiple country-specific tax reports and to identify specific data unique to each report. The various business operations systems, including a payroll system and the tax reporting system, are connected to a reconciliation system that implements reconciliation processes using a business warehouse. The business warehouse can collect and store all relevant data collected by the various business operations systems, and can be queried for all or portions of the data. In response to a query from the reconciliation system to reconcile data in a particular tax report with data in a payroll report, the tax reporting system can provide the common data and the specific data that is specific to the particular report to a reconciliation system, which can then perform the reconciliation operations.

By implementing the techniques described below, a single generic framework to reconcile payroll reports with tax statements can be developed. Consequently, as many reconciliation applications as the number of tax statements need not be developed. The reconciliation process can be automated, resulting in a decrease in the need for human intervention and in the effort and cost to develop and maintain the reconciliation solution. The automation can further improve the efficiency and speed of reconciliation and can minimize errors relative to manual reconciliation. Further, such a framework can eliminate redundancy and provide a solution that is flexible to obtain data to provide for reconciliation and to query the obtained data. Functionalities of independent business operations systems, including those offered by third parties external to the business enterprise, can be reconciled with ease and higher accuracy. The processes of obtaining the data can be simplified and adopted to extend to multiple tax reports. The framework can also support the reconciliation processes as described below.

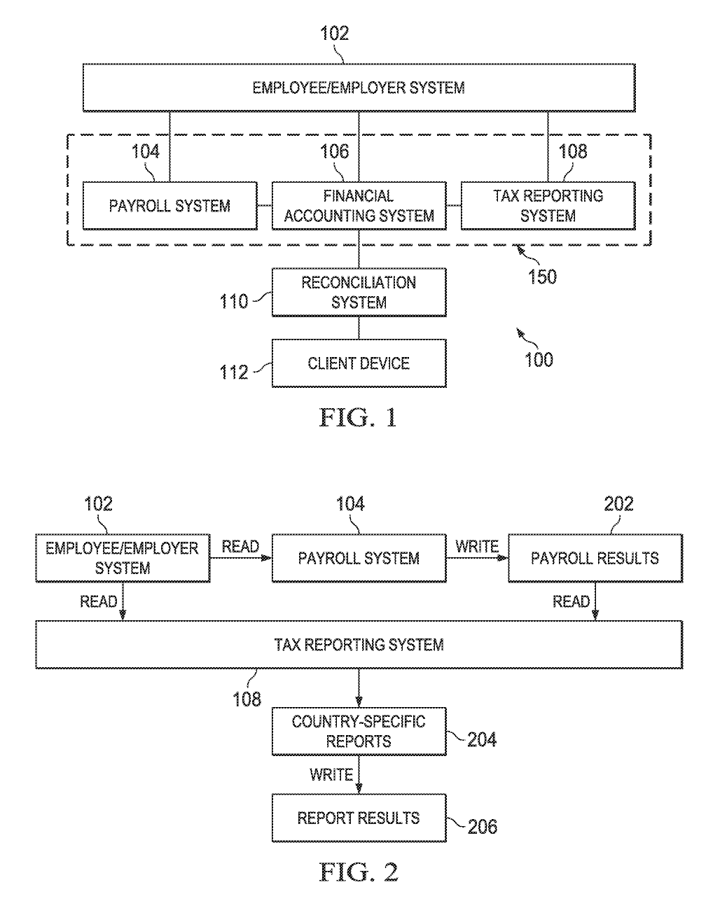

FIG. 1 illustrates an example environment 100 for implementing various features of business operations systems that can perform reconciliation. In the environment 100, an employee/employer system 102 (EE system) is connected to multiple business operations systems 150 including a payroll system 104, a financial accounting system 106, and a tax reporting system 108. Each system can be configured to perform operations related to one aspect of a business organization, which can include obtaining data. Each system can further be configured to generate reports from the data. Alternatively, or in addition, each system can include or be connected to a business warehouse. The systems can provide the collected data to the business warehouse, which can be configured to generate the reports.

The business operations systems 150 can be connected to a reconciliation system 110 configured to reconcile data in reports generated by one of the systems with data in reports generated by other systems. Each system can include respective data processing apparatus that can execute instructions, for example, computer program instructions, stored on respective computer-readable medium to perform operations. In some implementations, the reconciliation system 110 can perform reconciliation operations in response to a reconciliation query received from a client device 110 (for example, a computer system).

The EE system 102 can include data describing employees and employers. The employee data can include employee names and identifiers, personal data of each employee, data describing remuneration including credits and debits to each employee's pay, data describing tax obligations of the employee, absences, and the like. The employer data can include employer names and legal identifiers, data describing employee-specific income and expenses of the employer, data describing tax obligations, for example, to governments of multiple countries, tax rates, and the like. The EE system 102 can include a computer-readable medium (not shown) in which the data can be stored. The EE system 102 can include data processing apparatus (not shown) that can perform operations to include data to and retrieve data from the computer-readable medium. For example, the data processing apparatus can receive a query for data pertaining to a particular employee, and, in response, obtain the data from the computer-readable medium, and provide the obtained data.

The payroll system 104 can be configured to process remuneration of human resources, for example, work done by each employee in the organization, specifically, for example, according to legal and business requirements of a respective country in which each employee is employed. For example, for each employee, the payroll system 104 can calculate gross and net pay, which includes individual payments and deductions calculated during a payroll period. In addition, for each employee, the payroll system 104 can calculate special payments, overtime payments, bonuses, and the like, that are to be paid to a respective employee during the payroll period.

The payroll period is variable and can be, for example, monthly, bi-monthly, weekly, and the like. The payroll system 104 can include data processing apparatus (not shown) which can execute instructions stored in a computer-readable medium (not shown) to calculate each employee's remuneration at specific time instants of a payroll period (for example, at the end of the payroll period). The payroll system 104 can determine the remunerations and provide the same to other systems of the organization, for example, the financial accounting system 106. In some implementations, the payroll system 104 can transfer the remunerations and other data that the payroll system 104 collects in the form of one or more reports. A report can be a summarized document describing, for example, all payments and deductions for each employee about whom data is stored in the EE system 102.

The financial accounting system 106 can be configured to record, manage, and summarize financial transactions of the organization. For example, the financial accounting system 106 can include data processing apparatus (not shown) to execute instructions stored on a computer-readable medium (not shown) to record business transactions according to defined document principles, which can provide an unbroken audit trail from financial documents to individual documents (such as, paychecks to employees or direct transfer statements). The financial accounting system 106 can enable creation of documents (for example, ledgers and sub-ledgers) describing business transactions. The system 106 can check that the balance of debits and credits received in a document total to zero. If so, then the system 106 can save the document and update account balances in the general ledger.

In some implementations, the financial accounting system 106 can receive data from the payroll system 104, create reports that summarize the data, and store the data in the financial accounting system 106. For example, the financial accounting system 106 can store a report that includes standard basic pays, each representing a company-related expense, and bank transfers, each represent a payable. The financial accounting system 106 can store the standard basic pays in an expenses account and a salaries account, and can store a corresponding payable in an account entitled “Wages and Salaries to be paid,” for example.

The tax reporting system 108 can be configured to generate payroll tax and other reports for government authorities of multiple countries in the format specified by the authority of each country. For example, the tax reporting system 108 can include data processing apparatus (not shown) that can execute instructions stored in a computer-readable medium (not shown) to generate the payroll tax and other reports. The country specific tax reports can help the organization to report tax and other statutory contributions or deductions withheld from employees. Other reports can include legal reports that help the organization to provide employees' payroll data to various agencies based on the laws of the country.

The reconciliation system 110 can be configured to implement comparison processes in which payroll reports are compared against reports generated by other systems (for example, the payroll system 104, the financial accounting system 106, the tax reporting system 108, and the like) to evaluate payroll results. For example, the reconciliation system 110 can include data processing apparatus (not shown) to execute instructions stored in a computer-readable medium (not shown) that perform operations including identifying the accuracy and consistency of the data flow between the payroll system 104 and other related systems within the enterprise.

In some implementations, the reconciliation system 110 can reconcile data in the various reports by implementing a two-step process. In a first comparison step, the reconciliation system 110 can compare the totals of the core information sources in the payroll system 104, the financial accounting system 106, the tax reporting system 108, and optionally one or more additional systems, at the core level. If the reconciliation system 110 identifies any differences in the comparison step, the reconciliation system 110 can then implement a second step in which the reconciliation system 110 can perform a detailed comparison (for example, a per employee, per payment, per earning or deduction element, or per pay period) to identify causes of the difference.

Each country can specify respective formats for one or more tax reports. For example, some tax formats specified by the United States include Form 940, Form 941, Form W2, and Form 1099-R. Another example of a tax format specified by Norway is an Annual Tax Statement. Each format specifies data (for example, fields) that are to be populated with respective values. Some portions of the data are common across all tax reports. For example, employee identifier and details, payroll details, amount details, and the like are generally included in all tax reports. Other portions are specific to each tax report. For example, the amount withheld, the frequency of reporting, whether the report is for a company or for an employee, and the like are specific to each tax report and depend on the requirements specified by the government authority requesting the report.

As described below, the tax reporting system 108 can identify the common data that is common to the multiple reports, and, in response to a query identifying a particular report, identify specific data that is specific to the particular report, and provide both the common data and the specific data to the reconciliation system 110. An example process for providing the common data and the specific data to the reconciliation system 110 is described with reference to FIGS. 2-4.

FIG. 2 illustrates example business operations systems to generate reports of payroll results. To generate payroll results 202, which includes reports describing payroll, the payroll system 104 can read employee or employer information (or both) from the EE system 102. To process the payroll results and generate the reports, the payroll system 104 can obtain, for example, data specific to the employee (such as, basic pay, absences, deductions, contributions, tax bracket, company-specific details, data about statutory/regulatory bodies, statutory forms, and the like), and generate payroll reports using the obtained data. The payroll system 104 can write the generated reports to the payroll results 202, which can include, for example, a computer-readable storage medium.

The tax reporting system 108 can be configured to generate country-specific tax reports for various countries, for example, the United States, Norway, Finland, and the like, according to the specifications of the government of each country. The tax reporting system 108 can generate country-specific tax reports 204 by obtaining data for the reports from both the EE system 102 and from the payroll results 202. The tax reporting system 108 can write the report results 206, for example, to a computer-readable medium. Some portions of the data using which the tax reporting system 108 generates the country-specific tax reports 204 are common across all reports, while other portions are specific to each report.

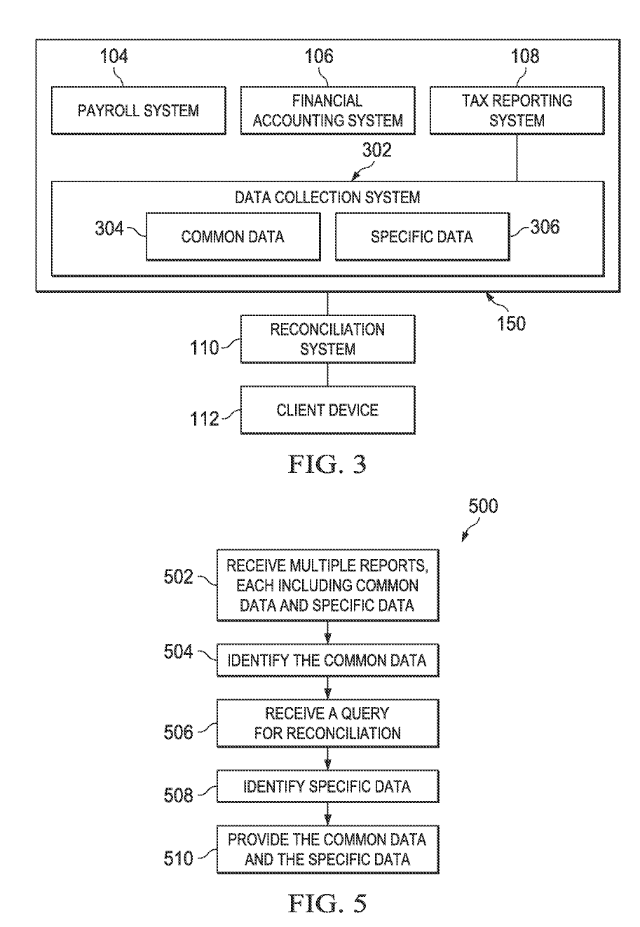

FIG. 3 illustrates a data collection system 302 to collect common data 304 and specific data 306, which can be stored in respective computer-readable media or in portions of the same computer-readable medium. The data collection system 302 can be connected to the tax reporting system 108, and can be implemented as a generic framework configured to identify common data that is common to the multiple tax reports generated by the tax reporting system 108. For example, the common data 304 that the tax reporting system 108 is configured to identify can include data describing payroll-related data associated with each employee. The data collection system 302 can associate tax codes with the each portion of the common data 304. A tax code can be a unique identifier associated with a portion of common data 304, for example, the portion based on age or gender of the payee (or both), source of income (such as, job or pension), taxable or non-taxable income, and the like. The data collection system 302 can include one or more computer-readable media to store the common data 304.

In addition, the generic framework implemented in the data collection system 302 can identify specific data 306 that is specific to each country-specific tax report that the tax reporting system 108 generates. For example, the specific data 306 for a Norwegian Annual Tax Statement can include a frequency of reporting (for example, yearly), tax cards, federal tax rates, and the like. The data collection system 302 can include one or more computer-readable media to store the specific data 306. In some implementations, the tax reporting system 108 can collect the data to generate the multiple reports and push the data to the data collection system 302, which can then identify and store the common data 304 and the specific data 306. Alternatively, the data collection system 302 can pull the data from the tax reporting system 108, or optionally from the payroll system 104 or the financial accounting system 106, or both.

As described above, the various business operations systems (for example, the payroll system 104, the financial accounting system 106, and the tax reporting system 108 generate reports from data collected by the respective systems. Of these systems, the tax reporting system 108 generates multiple country-specific tax reports. The reconciliation system 110 can reconcile data in at least one report of the multiple country-specific tax reports and a report generated by one of the other business operations systems, for example, the payroll system 104.

In some implementations, the reconciliation system 110 can receive input from a client device 112 (for example, a computer system) to reconcile a tax report generated by the tax reporting system 108 and a payroll report generated by the payroll system 104. In response to receiving the input, the reconciliation system 110 can transmit a query to the business operations systems 150 for the tax report and the payroll report. In some implementations, the reconciliation system 110 can include a tax code associated with the tax report in the query. The payroll system 104 can identify the requested payroll report, and provide the same to the reconciliation system 110 in response to receiving the query.

The data collection system 302 can receive the query requesting the tax report. In particular, the data collection system 302 can receive the tax code included in the query. In response, the data collection system 302 can identify the common data, for example, associated with the tax code. Further, the data collection system 302 can identify the specific data included in the tax report. The data collection system 302 can provide the specific data to the reconciliation system 110, which can then reconcile the tax report and the payroll report.

To reconcile the tax report and the payroll report, the reconciliation system 110 can generate a report that is substantially identical (for example, an exact copy or a mirror image) of the tax report in a form that is substantially similar to a form of the payroll report. Thus, by generating the copy of the tax report, the reconciliation system 110 can obtain the common data and the specific data in the tax report. The reconciliation system 110 can perform the reconciliation process by implementing the two-step process of comparing and drilling down. The reconciliation system 110 can generate a reconciliation report based on the reconciling, and present (for example, display) the reconciliation report in a display device (not shown) connected to the client device 112.

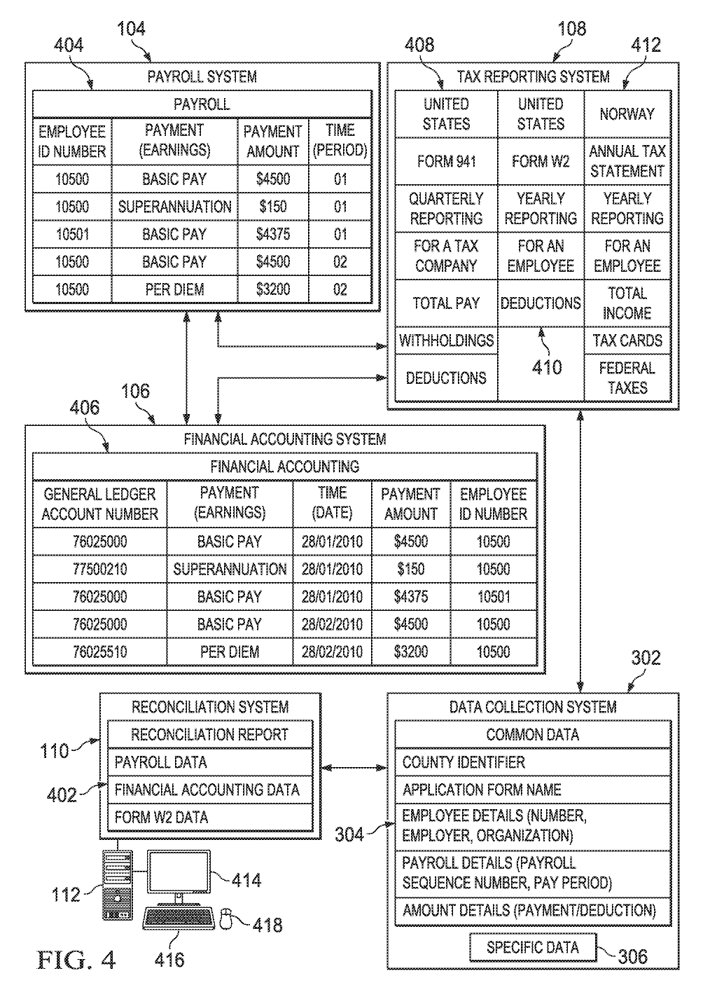

FIG. 4 illustrates examples of reports generated by the business operations systems. For example, the payroll system 101 and the financial accounting system 106 generate a payroll report 404 and a financial accounting report 406, respectively. The tax reporting system 108 generates three reports—a first tax report 408 (a United States Form 941), a second tax report 410 (a United States Form W2), and a third tax report 412 (a Norwegian Annual Tax Statement). The data collection system 302 stores common data 304 that includes, for example, a country identifier, an application form name, employee details (such as, number employer, organization), payroll details (such as, payroll sequence number, pay period), and amount details (such as, payments and deductions).

The reconciliation system 110 provides a query to reconcile the payroll report 404, the financial accounting report 406, and the second tax report 410. In response, the data collection system 302 identifies specific data 306 that is specific to the second tax report 410. The data collection system 302 provides the common data 304 and the specific data 306 to the reconciliation system 110. The reconciliation system 110 generates a reconciliation report 402, and provides the same to the client device 112. The client device 112 can display the reconciliation report 402 in the display device 414. Further, the client device 112 can receive input to reconcile reports using input devices (for example, a keyboard 416, a mouse 418, and the like).

Examples of data that the tax reporting system 108 includes in a tax report, for example, the third tax report 412, are shown in Table 1.

TABLE 1
Examples of data in a tax report.

| Code No. | Data type |
|---|---|
| 1 | Unique Employer Identification |
| 2 | Record Identifier for Annual Tax Statement (Grouping |
| | identifier for reporting on tax category, for example, |
| | expatriates, residents, non-residents) |
| 3 | Tax form application or report name |
| 4 | Reporting period end date |
| 5 | Date of report generation |
| 6 | Time of report generation |
| 7 | Unique identifier of report execution (no simulation |
| | run) identifier for the Annual Tax Statement. |
| | Multiple runs are possible, each to obtain an |
| | original, a print, a re-print, a duplicate, and the like. |
| 8 | Sub application |
| 9 | Reporting period begin date |
| 10 | Year for which levy is to be carried out |
| 11 | Unique payroll sequence number for every employee |
| 12 | Company code |

Examples of data that the payroll system 104 includes in a payroll report, for example, the payroll report 404, are shown in Table 2.

TABLE 2
Examples of data in a payroll report.

| Code No. | Data type |
|---|---|
| 1 | Unique payroll sequence number for every employee |
| 2 | Unique employee identifier |
| 3 | Work area of employee (grouping identifier for reporting) |
| 4 | Tax form group identifier 1. This field corresponds |
| | to the final accumulated values calculated using |
| | another tax code value for the United States |
| | and as payment times for Finland, for example. |
| 5 | Tax form group identifier 2 (sub-section of code no. 4). |
| | Accumulated value of wage types are reported as final result. |
| 6 | Payroll identifier |
| 7 | Payment of wage element indicator |
| 8 | Indicator to flag employee or employer contribution. |
| 9 | HR payroll: amount |
| 10 | HR payroll: Number |
| 11 | Symbolic identifier for deduction or earning (for example, |
| | +/−, where “+” indicates amount added to tax code and |
| | “−” indicates amount subtracted from tax code. |
| 12 | Currency key |
| 13 | Cost center |

Thus, the payroll system 104 calculates payments, deductions, and contributions for all employees every pay period. The tax reporting system 108 generates reports to report the employees' income and deductions to government authorities of various countries. From the data gathered by the tax reporting system 108, each country may want to extract country specific data, extract employee specific data, for example, from payroll results and master data in the EE system 102, and display data grouped according to country dependent object, for example, tax authority for United States, business number for Australia.

The generic framework implemented in the data collection system 302 can capture the data required for varied country dependent reporting on payroll results. The reconciliation system 110 can reconcile the data to check the accuracy of business transactions between payroll and other integrated functions. The reconciliation system 110 can trigger reconciliation process to ensure the completeness of business transactions, for example, by identifying missing step or steps in a sequence or sequences of actions. The system 110 can further highlight any erroneous action in the sequence and trigger rectification measures. Such reconciliation processes can also serve legal auditing purposes.

FIG. 5 is a flowchart showing an example process 500 to collect data distributed across multiple reports. The process 500 can be implemented as computer program instructions executable by data processing apparatus, for example, data processing apparatus of the tax reporting system 108. The process 500 receives multiple reports generated by a first business operations system, for example, the tax reporting system 108 (step 502). The multiple reports can include common data that is common to the multiple reports. Each report can include specific data that is specific to a respective report. The process 500 can identify the common data (step 504). The process 500 can receive a query for reconciliation of data in at least one report of the multiple reports and a report generated by a second business operations system, for example, the payroll system 104 (step 506). In response to receiving the query for reconciliation, the process 500 can identify specific data that is specific to the at least one report (step 508). The process 500 can provide the common data and the specific data, for example, to the reconciliation system 110 (step 510). The reconciliation system 110 can reconcile the received data.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical and/or non-transitory components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-8. (canceled)

9. A non-transitory computer-readable medium tangibly encoding computer program instructions executable by data processing apparatus to perform operations comprising:
receiving a plurality of reports generated by a tax reporting system, each report including respective data, wherein the plurality of reports include common tax data that is common to the plurality of reports, and wherein each report includes respective specific tax data that is specific to a respective report;
identifying the common tax data; and
in response to receiving a query for reconciliation of data in at least one report of the plurality of reports and a report generated by a human resource payroll system:
identifying specific tax data that is specific to the at least one report, and
providing at least a portion of the common tax data and the identified specific tax data.

10. The medium of claim 9, wherein the tax reporting system is configured to generate country specific tax reports for a plurality of countries and for a plurality of employees,
wherein the common tax data includes data describing at least one of an employee, payroll details for the employee, and amounts payable to the employee, and
wherein the specific tax data includes at least one of a tax form identifier, a country identifier, and a frequency of report generation.

11. The medium of claim 9, the operations further comprising:
associating a plurality of codes with a plurality of portions of the common tax data, wherein each code specifies parameters based on which data in a respective portion is grouped; and
receiving a particular code associated with the at least the portion of the common tax data with the query.

12. The medium of claim 9, the operations further comprising:
receiving the report generated by the human resource payroll system; and
reconciling the data in at least one report of the plurality of reports and the report generated by the human resource payroll system.

13. The medium of claim 12, wherein reconciling the data comprises generating a report that is substantially identical to the at least one report of the plurality of reports in a form substantially similar to a form of the report generated by the human resource payroll system.

14. The medium of claim 13, wherein generating the report that is substantially identical to the at least one report of the plurality of reports comprises:
generating a copy of the at least one report of the plurality of reports; and
obtaining the common tax data and the specific tax data that is specific to the at least one report from the mirror image.

15. The medium of claim 12, the operations further comprising:
generating a reconciliation report based on reconciling the data in at least one report of the plurality of reports and the report generated by the human resource payroll system; and
displaying the reconciliation report.

16. A system comprising:
data processing apparatus; and
a non-transitory computer-readable medium tangibly encoding computer program instructions executable by the data processing apparatus to perform operations comprising:
receiving a plurality of reports generated by a tax reporting system, each report including respective data, wherein the plurality of reports include common tax data that is common to the plurality of reports, and wherein each report includes respective specific tax data that is specific to a respective report;
identifying the common tax data; and
in response to receiving a query for reconciliation of data in at least one report of the plurality of reports and a report generated by a human resource payroll system:
identifying specific tax data that is specific to the at least one report, and
providing at least a portion of the common tax data and the identified specific tax data.

17. The system of claim 16, wherein the tax reporting system is configured to generate country specific tax reports for a plurality of countries and for a plurality of employees,
wherein the common tax data includes data describing at least one of an employee, payroll details for the employee, and amounts payable to the employee, and
wherein the specific tax data includes at least one of a tax form identifier, a country identifier, and a frequency of report generation.

18. The system of claim 16, further comprising:
associating a plurality of codes with a plurality of portions of the common tax data, wherein each code specifies parameters based on which data in a respective portion is grouped; and
receiving a particular code associated with the at least the portion of the common tax data with the query.

19. The system of claim 16, further comprising:
receiving the report generated by the human resource payroll system; and
reconciling the data in at least one report of the plurality of reports and the report generated by the human resource payroll system.

20. The system of claim 19, wherein reconciling the data comprises generating an image of the at least one report of the plurality of reports in a form substantially similar to a form of the report generated by the human resource payroll system, and wherein generating the image comprises:
generating a mirror image of the at least one report of the plurality of reports; and
obtaining the common tax data and the specific tax data that is specific to the at least one report from the mirror image.

21. A computer-implemented method comprising:
receiving a plurality of reports generated by a tax reporting system, each report including respective data, wherein the plurality of reports include common tax data that is common to the plurality of reports, and wherein each report includes respective specific tax data that is specific to a respective report;
identifying the common tax data; and
in response to receiving a query for reconciliation of data in at least one report of the plurality of reports and a report generated by a human resource payroll system:
identifying specific tax data that is specific to the at least one report, and
providing at least a portion of the common tax data and the identified specific tax data.

22. The method of claim 21, wherein the tax reporting system is configured to generate country specific tax reports for a plurality of countries and for a plurality of employees,
wherein the common tax data includes data describing at least one of an employee, payroll details for the employee, and amounts payable to the employee, and
wherein the specific tax data includes at least one of a tax form identifier, a country identifier, and a frequency of report generation.

23. The method of claim 21, further comprising:
associating a plurality of codes with a plurality of portions of the common tax data, wherein each code specifies parameters based on which data in a respective portion is grouped; and
receiving a particular code associated with the at least the portion of the common tax data with the query.

24. The method of claim 21, further comprising:
receiving the report generated by the human resource payroll system; and
reconciling the data in at least one report of the plurality of reports and the report generated by the human resource payroll system.

25. The method of claim 24, wherein reconciling the data comprises generating a report that is substantially identical to the at least one report of the plurality of reports in a form substantially similar to a form of the report generated by the human resource payroll system.

26. The method of claim 25, wherein generating the report that is substantially identical to the at least one report of the plurality of reports comprises:
generating a copy of the at least one report of the plurality of reports; and
obtaining the common tax data and the specific tax data that is specific to the at least one report from the mirror image.

27. The method of claim 24, further comprising:
generating a reconciliation report based on reconciling the data in at least one report of the plurality of reports and the report generated by the human resource payroll system; and
displaying the reconciliation report.
